(19) United States
(12) Patent Application Publication
(10) Pub. No.: US 2008/0121543 A1
(43) Pub. Date: May 29, 2008

(54) Coordination System & Method

(76) Inventor: Kamile Bartlett, Bountiful, UT (US)

Correspondence Address: ADVANTIA LAW GROUP, 9035 SOUTH 1300 EAST, SUITE 200, SANDY, UT, 84094, US

(21) Appl. No.: 11/463,276

(22) Filed: Aug. 8, 2006

(51) Int. Cl. B65D 85/00; B42D 15/00

(52) U.S. Cl. 206/449; 283/70

(57) ABSTRACT

A coordination system and method for organizing and moving objects is disclosed, including: a first label housing, having a first opening; a first plurality of labels, disposed substantially within the first label housing, having a first visual appearance, and sized to enable one of the first plurality of labels to pass through the first opening; a second label housing, having a second opening; a second plurality of labels, disposed substantially within the second label housing, having a second visual appearance substantially different than the first visual appearance, and sized to enable one of the second plurality of labels to pass through the second opening; and an index system, coordinated to the first and second plurality of labels, respectively, configured to index the first and second visual appearances, respectively.

### BACKGROUND OF THE INVENTION

1. Field of the Invention

The present invention relates to methods of storing, arranging, and/or transporting objects from one location to another. Specifically, systems and methods for packing and moving using coordination of labels.

2. Description of the Related Art

In the related art, it has long been known to use filing/labeling systems or apparatus to systematically organize, store, identify, and/or locate a plurality of items for future use or consumption. It is known that items tend to get loss or misplaced easily; especially when they are moved around frequently. To reduce such occurrences, various sorts of labels, tapes, signs and other forms of adhesive identifiers are known and used widely in a range of applications where they can be attached to bottles, books, files, storage media, computer diskettes, and a large number of other products. This allows users to quickly place, identify, and track packages or products in desired locations and relocate them in the future as needed. Such systems can be of significant value to people and businesses desire a quick and efficient method of organizing and managing numerous amounts of inventory or personal belongings. The following are examples of related art that are provided herein for their related teachings, and are herein incorporated by reference for their supportive teachings

U.S. Pat. No. 5,687,895, by Alison, et al., disclose an interlocking arrangement of storage boxes in the rear section of a passenger vehicle such as a sport utility vehicle. The arrangement preferably includes at least three storage boxes. Two of the boxes are respectively secured to the side walls of the vehicle. These side boxes are spaced from each other and the third box is slidably receivable between them. In the preferred embodiment, the third box has lips on its sides that respectively interlock with lips on the two side boxes to prevent the third box from being removed by lifting it upwardly between the two side boxes. Forward stops on the side boxes prevent the third box from being moved forwardly beyond the side boxes and the vehicle's tailgate in its closed position serves to prevent the third box from being moved rearwardly out of the vehicle. In this manner and with the tailgate in its locked, closed position, the three interlocking storage boxes are securely held in place.

U.S. Pat. No. 5,501,564, by Doche, disclose a system for storing and distributing flat objects to different working stations is provided. The system comprises storage modules, transportation or conveying modules and distribution modules. All these modules are placed alongside one another to form a continuous chain. Each module has fixed or mobile rollers constituting two superimposed displacement tracks for operating in two opposite directions. Portable racks are also provided. Particular utility is found in storage and transportation of boxes containing silicon wafers.

U.S. Pat. No. 4,889,254, by Vola, disclose a box of molded plastic material for packaging or storage of various objects has a box body of polygonal cross-section which may be square, for example, and a closure lid. The different sides of the box are provided with complementary male and female guides of dovetail shape, for example. The guides of one of the two series have a stop at one end. The arrangement is such that a variable number of boxes of this type can be assembled side by side so as to constitute a single-unit assembly. The boxes can be employed for individual packaging of various objects or products such as make-up products, for example.

U.S. Pat. No. 4,863,222, by Posso, discloses an arrangement constituted by a stack of boxes intended to contain drawers, in particular for the storage of audio and video recording tapes. The boxes have different dimensions. The widths and heights of the boxes are dimensioned to adapt to the contents and to allow a large number of combinations. On their upper side, the boxes comprise profiled ribs on which are fitted grooves of matching profile provided on a lower side of the boxes.

However, such methods fail to completely solve challenges associated with identifying, organizing, storing, large amounts of items being moved from one location to the next. Additionally, the existing methods mentioned above tend to be expensive, unsystematic, inefficient, time-consuming, difficult to use, and/or do not significantly reduce loss or misplacement of items.

What is needed is a system and/or method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available moving systems. Accordingly, the present invention has been developed to provide a coordination system for organizing and moving objects using labels.

In one embodiment, there may be a coordination system for organizing and/or moving objects, including: a first label housing, including a first opening; a first plurality of labels, disposed substantially within the first label housing, including a first visual appearance, and/or sized so that a cross-sectional profile of one of the first plurality of labels may be smaller than the first opening, enabling one of the first plurality of labels to pass through the first opening; a second label housing, including a second opening; a second plurality of labels, disposed substantially within the second label housing, including a second visual appearance substantially different than the first visual appearance, and/or sized so that a cross-sectional profile of one of the second plurality of labels may be smaller than the second opening, enabling one of the second plurality of labels to pass through the second opening; and/or an index system, coordinated to the first and/or second plurality of labels, respectively, configured to index the first and/or second visual appearances, respectively.

In another embodiment, the index system may include a direction of travel coordinated to each of the first and/or second visual appearances, respectively.

In still another embodiment, the first visual appearance may include a first color; and/or the second visual appearance may include a second color substantially different than the first color.

In yet another embodiment, the rear side of the first and/or second plurality of labels may include a layer of a pressure-sensitive adhesive, disposed over between about 70%-95% of the rear sides, respectively.

In still yet another embodiment, the first and/or second label housings may include a coupling member near a surface of the first and/or second label housings, respectively, configured to couple the first and/or second label housings to an object.

In even another embodiment, the coupling member may include a pressure-sensitive adhesive.

In even still another embodiment, the method for using a coordination system to organize and move objects, may include the following steps: coupling a label housing, containing a plurality of labels, and/or including an opening sized greater than the cross-sectional profile of one of the plurality of labels, to a surface; removing a label from the label housing by grasping the label, and/or pulling the label through the opening of the label housing; attaching the label to an object to designate the location of the object; indexing the label in a system index to coordinate the designated location of the object to the label; and/or moving the object from one location to another as designated by the label.

In even yet another embodiment, the plurality of labels may include a visual appearance.

In a further embodiment, the visual appearance may be a color.

In still a further embodiment, the label housing may be coupled to a surface by an adhesive.

In yet a further embodiment, the rear side of the plurality of labels may include a layer of pressure-sensitive adhesive disposed over between about 70%-95% of the rear side.

In still yet a further embodiment, the method for using a coordination system may include the step of packing the object.

In even a further embodiment, the coordination system for organizing an moving objects, may include: a label housing, including an opening; and/or a plurality of labels, disposed substantially within the label housing, including a visual appearance, wherein the plurality of labels may be sized so that a cross-sectional profile of one of the plurality of labels may be smaller than the opening, enabling one of the plurality of labels to pass through the opening, and/or wherein a rear side of the plurality of labels includes a layer of a pressure-sensitive adhesive, disposed over about 70%-95% of the rear side.

In even still a further embodiment, the coordination system includes an index system, coordinated to the plurality of labels, configured to index the visual appearances.

In even yet a further embodiment, the index system may include a direction of travel coordinated to the visual appearance.

In an additional embodiment, the visual appearance may include a color.

In still an additional embodiment, the label housing may include a coupling member, near a surface of the label housing, configured to couple the label housing to an object.

In yet an additional embodiment, the coupling member may include a pressure-sensitive adhesive.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective sectional side view of a coordination system according to on embodiment of the invention;

FIG. 2 illustrates a perspective rear view of a label according to one embodiment of the invention;

FIG. 3 illustrates a front planar view of a label according to one embodiment of the invention;

FIG. 4 illustrates a flowchart describing a method of using a coordination system to remove packed boxes from storage locations according to one embodiment of the invention; and

FIG. 5 illustrates a flowchart describing a method of using a coordination system to deliver packed boxes to storage locations according to one embodiment of the invention.

FIG. 6 illustrates a coordination system index according to one embodiment of the invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

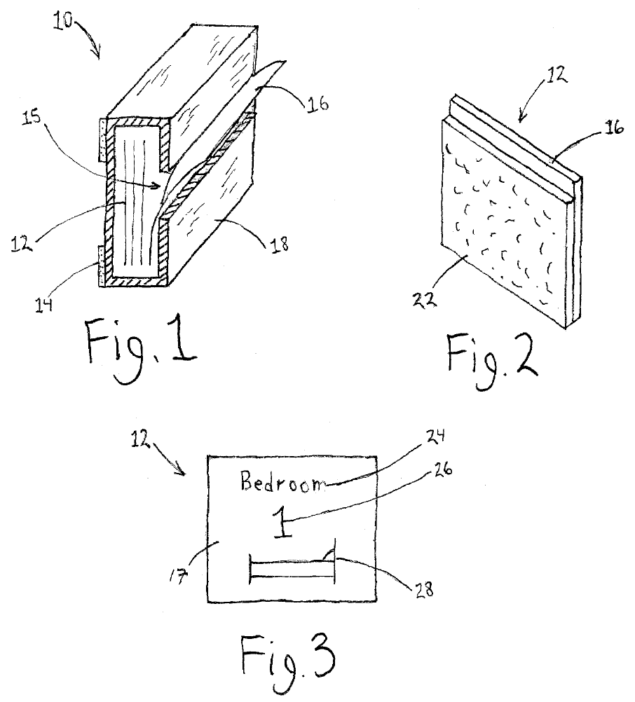

FIG. 1 illustrates a perspective sectional side view of a coordination system 10 having a color-coded label housing device 18 according to one embodiment of the invention. As shown, the device may be designed to house a plurality of color-coded labels 12 therein, where the rear of such may be removably mounted on hardened surfaces such as walls, doors, tables, etc. by the use of pressure-sensitive adhesive material 14 in the form of glue, tape, etc. A user may retrieve a color-coded label 12 by pulling a non-sticky surface or tab 16 outward through the opening 15 of the housing device 18 or detaching such from any other surface.

Mounting the housing device 18 on a room door or adjacent wall leading into a room would preclude a user from inadvertently forgetting to properly mark boxes or storage apparatus. Thus, the user can systematically locate, move, and organize boxes or storage apparatus quickly prior to transport and/or upon delivery to a desired location.

FIG. 2 illustrates a perspective rear view of a color-coded tab 12 according to one embodiment of the invention. The exaggerated illustration of the label 12 includes an upper non-sticky surface or tab 16 on its upper surface and a sticky surface or layer 22 on its lower surface. The adhesive layer 22 spanning the lower surface of the label 12 has properties which allow a user to removably attach such to movable objects and/or storage apparatus (not shown) such as boxes, containers, etc.

As illustrated in FIG. 2 according to another embodiment of the invention, the unsticky surface or tab 16 may cover from 5% or to/or from 10% or to/or from 15% or to/or from 20% or to/or from 25% to 30% of the rear label 12. This enables a user to quickly pull the tab 16 out of the housing device 18 as described in FIG. 1. In addition, the sticky surface or layer 22 may cover from 70% or to/or from 75% or to/or from 80% or to/or from 85% or to/or from 90% to 95% of the rear label 12 enabling the label to be securely attachable to objects and/or storage apparatus. This is the case whether or not storage apparatus is stationary and/or being transported from one place to another. Thus, this relatively large percentage of coverage reduces the probability of the label 12 falling off storage apparatuses or boxes, especially dusty ones, being transported from and to various locations.

One advantage of having the unsticky surface or tab 16 spanning the top portion of the label 12 is that is allows a user to comfortably pull the labels 12 off of boxes placed in the desired rooms versus having the tab 16 area on the bottom of the label, requiring the user to twist his or her hands in an uncomfortable position in order to take the labels 12 off. Additionally, unlike regular stickies, the labels 12 stick to various surfaces better because a larger portion of the label has a sticky surface or layer 22 thereon.

It is also noted that sticky surface or layer 22 portion of the label 12 shown in FIG. 2 may be constructed of coated paper integrated with adhesive-making and silicone rubber, film-spray, plastic and silicone coating, film pressing, coating and laminating, etc.

FIG. 3 illustrates a front planar view of a label 12 according to one embodiment of the invention. As illustrated, a user may mark the label 12 with designator words 24, numerals 26, and/or pictures or graphics 28 and attach such to a plurality of objects or storage apparatus (not shown) that are positioned in designated locations within the confines of real property or buildings such as bedrooms, bathrooms, storage rooms, family rooms, etc. for example. This would make it easy for the user to quickly identify and move objects and/or storage apparatus from one place to another without misplacing them.

In another embodiment of the invention as illustrated in FIG. 3, a display surface 17 may be color-coded to correspond with a class or group of objects and/or storage apparatus positioned in any given room. For example, blue tabs 12 attached to storage apparatus may indicate bedroom items, red tabs 12 may be attached to storage apparatus containing family room items, etc.

Additionally, in yet another embodiment of the invention shown in FIG. 3, a user may mark the tabs 12 with various words 24. For example, the word 24 “Bedroom” clearly identifies items in the bedroom. Likewise, the word 24 “Kitchen” indicates objects in the kitchen, etc. Further, a user may mark the tabs 12 with numerals 26. For example, a tab 12 with a numeral 26 “1” marked on it as shown in FIG. 3 indicates that only one box in a given room has bedroom items in it. In another example, a tab 12 with numeral 26 “8” marked on it corresponds to 8 boxes with bedroom objects being in a desired room. Finally, a user may mark the tabs 12 with various graphics 28. For example, a graphic 28 of a bed marked on the tab 12, as illustrated in FIG. 3, clearly indicate bedroom items. A graphic 28 of an oven may indicate kitchen items.

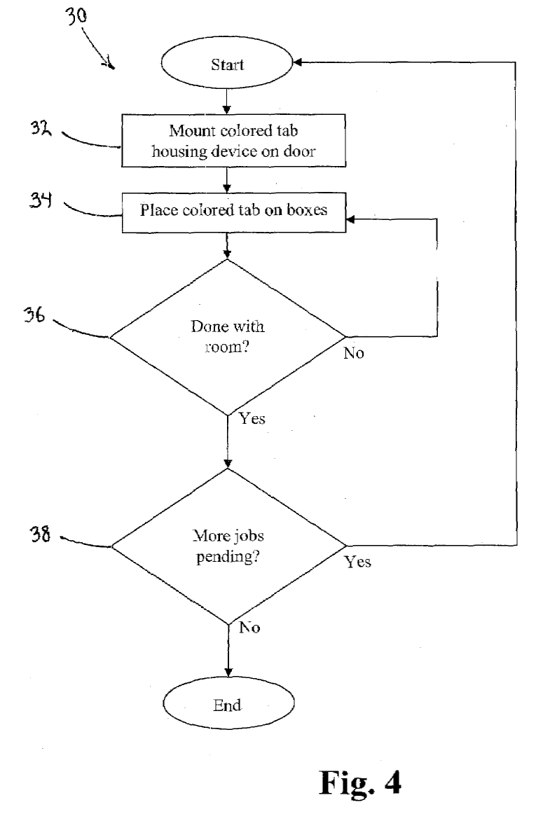

FIG. 4 illustrates a flowchart outlining a method of using a coordination system 10 to remove packed boxes from storage locations (not shown) according to one embodiment of the invention. A storage location may be designated real property, buildings, etc. In operation, a user may systematically pack and move objects and/or storage apparatus from the store location to another. A user may start the process beginning in step 32 by mounting the color coordination system housing device 18 to doors or adjacent walls/panels within the confines of real property or buildings. This facilitates quick identification and retrieval of color-coded labels 12 prior to attaching such to storage apparatus or objects in a room.

After packing storage apparatus or containers with objects positioned in a given room, the user may implement step 34 by pulling a non-sticky surface or tab 16 extending outward from the opening 15 of the housing device 18 and attach the sticky surface or layer 22 of the label 12 to packed storage apparatus as he or she leaves a given room inside of a storage location. If the user isn't finished working in a given room per step 36, he or she can repeat step 34.

If the user is done with a particular room according to step 36, the user may proceed to mount another color-coded label housing device 18 following the same procedure described in step 32. Afterwards, a user must determine if there are any more jobs pending according to step 40. If there are more jobs to complete, the user can repeat the method 30 as illustrated in FIG. 4. If there are no pending jobs, the user can end the process.

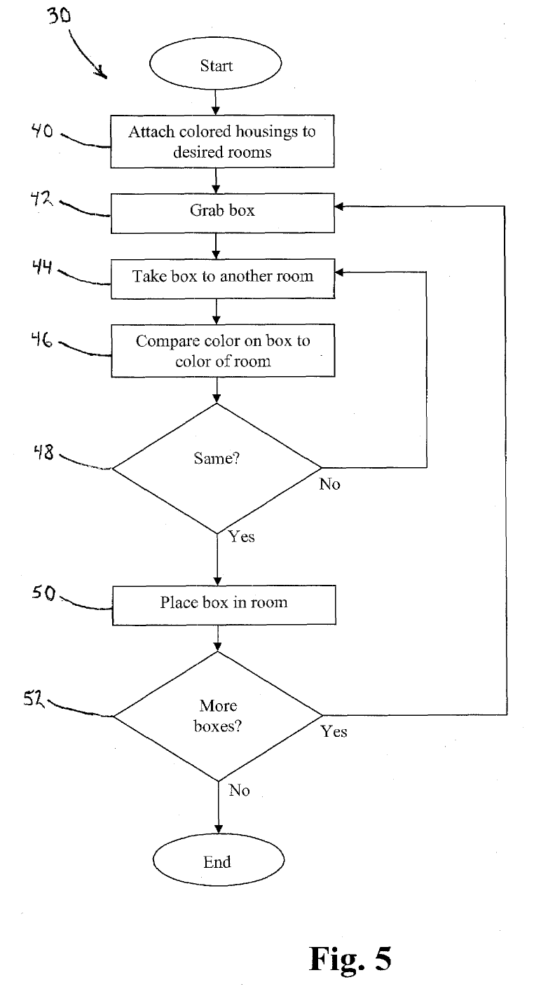

FIG. 5 illustrates a flowchart describing a method of using a coordination system 10 to deliver packed storage apparatus (not shown) to storage locations according to one embodiment of the invention. In operation, upon arrival to a given location, a user can attach label housing devices 18 to desired rooms per step 40.

Additionally, users may proceed to step 42 and grab a box or storage apparatus with color-coded labels 12 attached thereto.

Further, users may take the box or storage apparatus to another room according to step 44 and compare the colored label 12 on box or storage apparatus to the color of the tab 16 extending outward from opening 15 of the housing devices 18 attached to door or adjacent area leading into a room per step 46. Based on the comparison, if the colors of the labels 12 correspond with each other, place the box or storage apparatus into the room according to step 48. However, if the colors don't match then take box to another room that has a matching label 12 color inside of the housing device 18.

Finally, the user then may proceed to step 52 and determine if there are anymore boxes to deliver to the storage location (not shown). If there are more packed boxes or storage apparatus available, the user can repeat method 30 described in FIG. 4 starting with step 42. If are no more boxes left, the user can end the process.

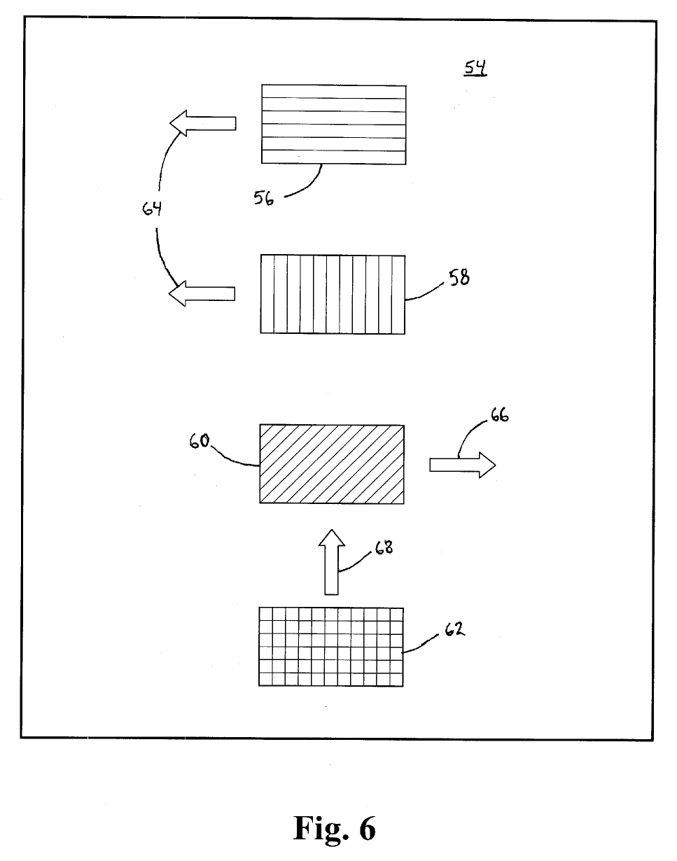

FIG. 6 illustrates a coordination system index 54 according to one embodiment of the invention. In operation, a user may mount this index 54 having colored portions with words or designators such as arrows giving him or her directions to the desired rooms. The user may place such on a wall near the main threshold to a hallway or stairway leading to rooms prior to distributing boxes or storage apparatus into the desired rooms.

A user reading the illustrated index 54 for example may quickly determine that he or she needs to turn left 64 through the hallway to place boxes with blue 56 and red or pink 58 labels 12 attached thereon into rooms with corresponding color schemes. In addition, the user may turn right 66 to place boxes with brown 60 labels 12 attached thereon into the desired room with matching labels 12 attached. Further, a user may walk upstairs 68 to place yellow or gold 62 labeled boxes into a room with matching colors. Using an embodiment of this index 54 would facilitate quick placement of color-coordinated boxes or storage apparatus into appropriate rooms and make for an effective and efficient distribution of packed boxes into the house or building.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the coordination system 10 and method 30 are designed to help users move objects and/or storage apparatus from one residential location to another in a systematic manner, one skilled in the art would know that the method 30 can be used to move objects in the commercial sector. For example, retailers, manufacturing warehouses, etc.

Further, the labels 12 may be removably attached to objects and/or storage apparatus that are made of plastic, wood, metal, cardboard, Styrofoam, etc.

It is also expected that there could be numerous ways to attach the housing device 18 to doors and/or other locations. For example, a user may use glue, thumb tacks, tape, etc.

Finally, it is envisioned that the label housing device 18 may be constructed of a variety of materials such as plastic, metal, cardboard, etc.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A coordination system for organizing and moving objects, comprising:
a first label housing, having a first opening;
a first plurality of labels, disposed substantially within the first label housing, having a first visual appearance, and sized so that a cross-sectional profile of one of the first plurality of labels is smaller than the first opening, enabling one of the first plurality of labels to pass through the first opening;
a second label housing, having a second opening;
a second plurality of labels, disposed substantially within the second label housing, having a second visual appearance substantially different than the first visual appearance, and sized so that a cross-sectional profile of one of the second plurality of labels is smaller than the second opening, enabling one of the second plurality of labels to pass through the second opening; and
an index system, coordinated to the first and second plurality of labels, respectively, configured to index the first and second visual appearances, respectively.

2. The coordination system of claim 1, wherein the index system includes direction of travel coordinated to each of the first and second visual appearances, respectively.

3. The coordination system of claim 2, wherein the first visual appearance includes a first color; and the second visual appearance includes a second color substantially different than the first color.

4. The coordination system of claim 3, wherein a rear side of the first and second plurality of labels includes a layer of a pressure-sensitive adhesive, disposed over between about 70%-95% of the rear sides, respectively.

5. The coordination system of claim 4, wherein the first and second label housings have a coupling member near a surface of the first and second label housings, respectively, configured to couple the first and second label housings to an object.

6. The coordination system of claim 5, wherein the coupling member includes a pressure-sensitive adhesive.

7. A method for using a coordination system to organize and move objects, comprising the following steps:
coupling a label housing, containing a plurality of labels, and having an opening sized greater than the cross-sectional profile of one of the plurality of labels, to a surface;
removing a label from the label housing by grasping the label, and pulling the label through the opening of the label housing;
attaching the label to an object to designate the location of the object;
indexing the label in a system index to coordinate the designated location of the object to the label; and
moving the object from one location to another as designated by the label.

8. The method of claim 7, wherein the plurality of labels have a visual appearance.

9. The method of claim 8, wherein the visual appearance is a color.

10. The method of claim 9, wherein the label housing is coupled to a surface by an adhesive.

11. The method of claim 10, wherein a rear side of the plurality of labels includes a layer of a pressure-sensitive adhesive, disposed over between about 70%-95% of the rear side.

12. The method of claim 11, further comprising the step of packing the object.

13. A coordination system for organizing and moving objects, comprising:
a label housing, having an opening; and
a plurality of labels, disposed substantially within the label housing, having a visual appearance, wherein the plurality of labels are sized so that a cross-sectional profile of one of the plurality of labels is smaller than the opening, enabling one of the plurality of labels to pass through the opening, and wherein a rear side of the plurality of labels includes a layer of a pressure-sensitive adhesive, disposed over about 70%-95% of the rear side.

14. The coordination system of claim 13, further comprising an index system, coordinated to the plurality of labels, configured to index the visual appearances.

15. The coordination system of claim 14, wherein the index system includes direction of travel coordinated to the visual appearance.

16. The coordination system of claim 15, wherein the visual appearance includes a color.

17. The coordination system of claim 16, wherein the label housing includes a coupling member, near a surface of the label housing, configured to couple the label housing to an object.

18. The coordination system of claim 17, wherein the coupling member include a pressure-sensitive adhesive.
